(19) United States
(12) Patent Application Publication
(10) Pub. No.: US 2018/0172536 A1
(43) Pub. Date: Jun. 21, 2018

(54) FIBER OPTIC PRESSURE APPARATUS, METHODS, and APPLICATIONS

(71) Applicant: Multicore Photonics, Inc., Orlando, FL (US)

(72) Inventors: Christian Adams, Yalaha, FL (US); Darren T. Engle, Orlando, FL (US); Robert S. Ryan, Oviedo, FL (US); Jody W. Wilson, Winter Springs, FL (US)

(73) Assignee: Multicore Photonics, Inc., Orlando, FL (US)

(21) Appl. No.: 15/736,118

(22) PCT Filed: Jun. 15, 2016
(86) PCT No.: PCT/US2016/037485

§ 371 Date: Dec. 13, 2017

Related U.S. Application Data
(60) Provisional application No. 62/181,261, filed on Jun. 18, 2015.

(51) Int. Cl. G01L 11/02; G01L 9/00

(52) U.S. Cl. CPC G01L 11/025; G01L 9/0076

(57) ABSTRACT

A pressure sensor device includes a pressure chamber housing, at least two separate pressure chambers within the housing, at least one pressure port fluidically coupled to each of the at least two pressure chambers, at least one pressure transmitting element per every two pressure chambers disposed in the pressure chamber, which separates the at least two pressure chambers, and at least two optical sensing elements disposed in at least one of the pressure chambers, wherein the at least two optical sensing elements are each optically coupled to an optical transmission medium.

### RELATED APPLICATION DATA

This application claims priority to U.S. Provisional application Ser. 62/181,261 filed Jun. 18, 2015, the subject matter of which is incorporated herein by reference in its entirety.

### BACKGROUND

### 1. Field of the Invention

Embodiments of the invention relate most generally to the field of pressure measurement. More particularly, embodiments and aspects of the invention are directed to fiber optic-based pressure measurement apparatus and methods, and applications including, but not limited to, the direct measurement and/or monitoring of differential pressure, gage pressure, and absolute pressure, as well as the indirect measurement and/or monitoring of fluid flow rate, liquid level, liquid density, fluid flow point velocity (using Pitot tube), filter screen quality monitoring, leak detection, and viscosity measurements.

### 2. Description of the Related Art

Diaphragm pressure sensors are the most common type of pressure sensors used for general purpose pressure measurements. The diaphragm pressure sensor can be traced back to Honeywell Regulator's 1954 patent U.S. Pat. No. 2,751,530 “Differential pressure sensing unit.” A diaphragm subject to pressure (or more accurately, to differential pressure resulting from two different pressures applied on both of its two sides) results in radial stress and tangential (hoop) stress. These stresses can be measured by strain gages attached to the diaphragm. Piezoresistive material, which changes electrical resistance when subject to strain, is widely used in more modern pressure sensors. The change in electrical resistance is measured by a Wheatstone bridge, which is usually integrated into the pressure sensing mechanism. The integrated device is called a pressure transducer, which produces a signal in the forms of electric current or voltage, which are proportional to pressure.

In more recent years, fiber optic based diaphragm pressure sensors have become an attractive option due to the high sensitivity of fiber optic-based sensors. Examples of this include diaphragm pressure sensors using the end surface of the optical fiber and a reflective diaphragm to form an interference cavity as disclosed, e.g., in WO2002023148. U.S. Pat. No. 6,304,686 “Methods and apparatus for measuring differential pressure with fiber optic sensor systems” employs fiber Bragg grating's (FBGs) and uses the pressure difference between two sources to impart a stress onto a fiber Bragg grating. This technique, however, does not take advantage of the increased sensitivity provided by measuring the radial and hoop stress of the diaphragm.

The inventors have recognized the need for pressure sensors in general and diaphragm-based pressure sensors in particular that employ fiber optical versus electrical sensing components and the benefits of their advantages which include immunity from electromagnetic interference (EMI), long distance signal transmission (e.g., tens of kilometers), greater sensitivity, bandwidth, and dynamic range, improved robustness, higher accuracy and efficiency, lower cost, and otherwise significantly broader range of applications.

### SUMMARY

Fiber optic diaphragm pressure sensors are gaining increasingly widespread usage due to the high sensitivity and stability of the sensors themselves, and the immunity fiber optic sensors exhibit to high temperatures, extreme RF and EMI fields, as well as chemical resistance. An optical fiber pressure sensor can be comprised of two fiber optic sensing elements attached to a flexing diaphragm of varying geometry and/or makeup, with the fiber able to sense radial and tangential strains at their installed positions. The contribution of both mechanical stresses caused by pressure and thermal stress caused by temperature are accounted for with the dual-sensor setup, and can solve for pressure and temperature simultaneously. Examples of this include pressure diaphragm monitoring that employs continuous fibers with embedded sensors, or where the optical fiber comprises a reflective diaphragm to form an interference cavity. Multicore fiber (MCF) sensor technology exhibits extremely high sensitivity to the radial and hoop stress of the diaphragm, several examples of which are described.

An embodiment of the invention is a pressure sensor device that includes a pressure chamber housing; at least two separate pressure chambers within the housing; at least one pressure port fluidically coupled to each of the at least two pressure chambers; at least one pressure transmitting element per every two pressure chambers disposed in the pressure chamber, which separates the at least two pressure chambers; and at least two optical sensing elements disposed in at least one of the pressure chambers, wherein the at least two optical sensing elements are each optically coupled to an optical transmission medium. In various embodiments the pressure sensor device may include the following features, limitations, characteristics alone or in various non-limiting combinations as one skilled in the art would understand.
wherein the pressure transmitting element is a diaphragm;
   wherein the pressure transmitting element is a flat-plate diaphragm;
      wherein the flat-plate diaphragm has a curvilinear shape.
      wherein the flat-plate diaphragm has a rectilinear shape;
   wherein the pressure transmitting element is a curved shell;
      wherein the curved shell is cylindrical;
      wherein the curved shell is spherical;
wherein the pressure transmitting element is a fiber Bragg grating (FBG);
   wherein the fiber Bragg grating is a reflective FBG;
   wherein the fiber Bragg grating is a transmissive FBG;
wherein the pressure transmitting element is an optical fiber-based interferometric sensor, such as a multicore fiber (MCF), twin-core fiber, and other such interferometric sensors known by those skilled in the art that exhibit a wavelength and/or amplitude dependence to changes in physical quantities such as temperature and pressure;
wherein each of the at least two pressure transmitting elements is disposed in at least one of a perpendicular orientation to the pressure transmitting element, a parallel orientation to the pressure transmitting element, in-plane to the pressure transmitting element, out-of plane to the pressure transmitting element, within at least one of the two separate pressure chambers, and outside of at least one of the two separate pressure chambers;
wherein the at least two optical sensing elements are configured in at least one of a serial optical, parallel optical, and serial/parallel optical connection;
wherein the at least two optical sensing elements are disposed in the sensor device by being one of bonded, printed, molded, and micro-fabricated.

### BRIEF DESCRIPTION OF THE DRAWINGS

FIG. 1 is a perspective sectional view of a fiber optic-based pressure sensor in which two fiber optic sensing elements are attached in-plane of a flat plate diaphragm, according to an exemplary aspect of the invention.

FIG. 2 is a perspective sectional view of a fiber optic-based pressure sensor in which one fiber optic sensing element is disposed perpendicular to a flat plate diaphragm and another fiber optic sensing element is coupled to an unstrained location to measure temperature and to compensate for temperature variation, according to an exemplary aspect of the invention.

FIG. 3 is a perspective sectional view of a fiber optic-based pressure sensor in which two fiber optic sensing elements are attached on or embedded in a curved shell in a housing, according to an exemplary aspect of the invention.

FIG. 4 is a perspective sectional view of a fiber optic-based pressure sensor in which one fiber optic sensing element is attached on or embedded in a curved shell in a housing and another fiber optic sensing element is coupled to an unstrained location to measure and/or compensate for temperature variation, according to an exemplary aspect of the invention.

FIG. 5 is a perspective sectional view of a fiber optic-based pressure sensor in which one fiber optic sensing element is disposed perpendicular to a curved shell in a housing and another fiber optic sensing element is coupled to an unstrained location to measure and/or compensate for temperature variation, according to an exemplary aspect of the invention.

FIG. 6 shows a perspective schematic view of a notional fiber Bragg grating (FBG) sensor, according to an illustrative embodiment of the invention.

FIG. 7 shows a schematic view of a notional optical fiber-based interferometric sensor, such as a multicore fiber (MCF) sensor, according to an illustrative embodiment of the invention.

### REFERENCE NUMERALS IN THE DRAWINGS

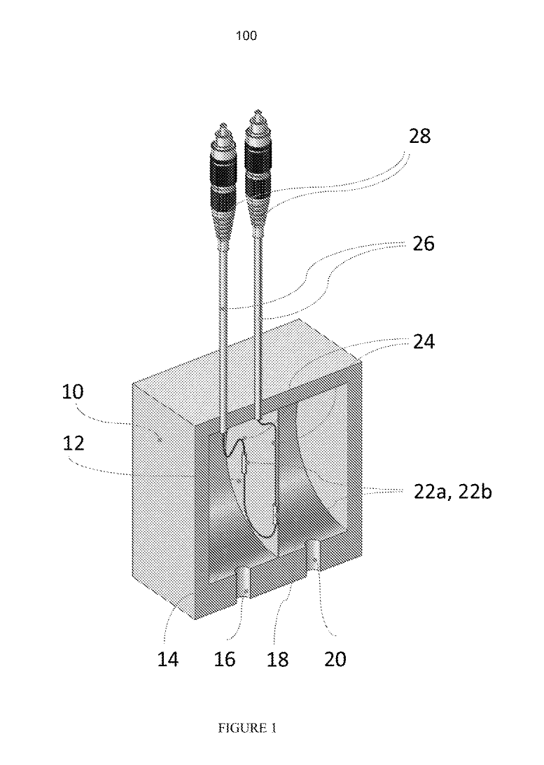

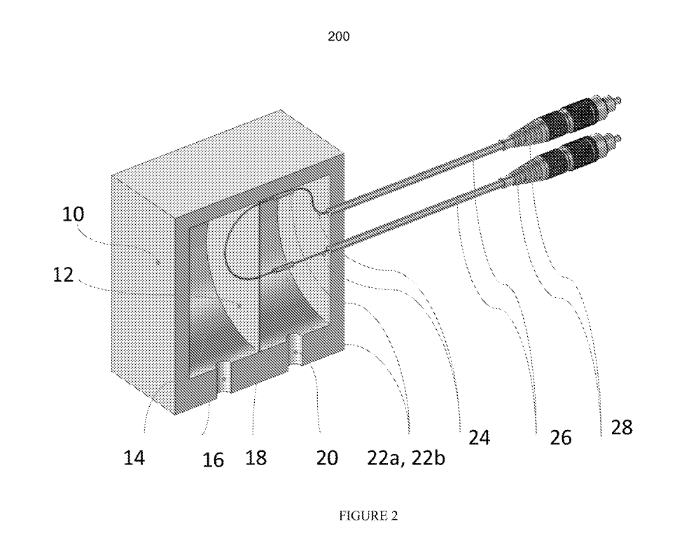

### FIGS. 1 and 2

10 sensor housing
12 pressure transmitting element (diaphragm)
14 pressure chamber 1
16 pressure port 1
18 pressure chamber 2
20 pressure port 2
22a, 22b fiber optic sensing elements
24 bare optical fiber
26 jacketed fiber optic cable
28 fiber optic connectors

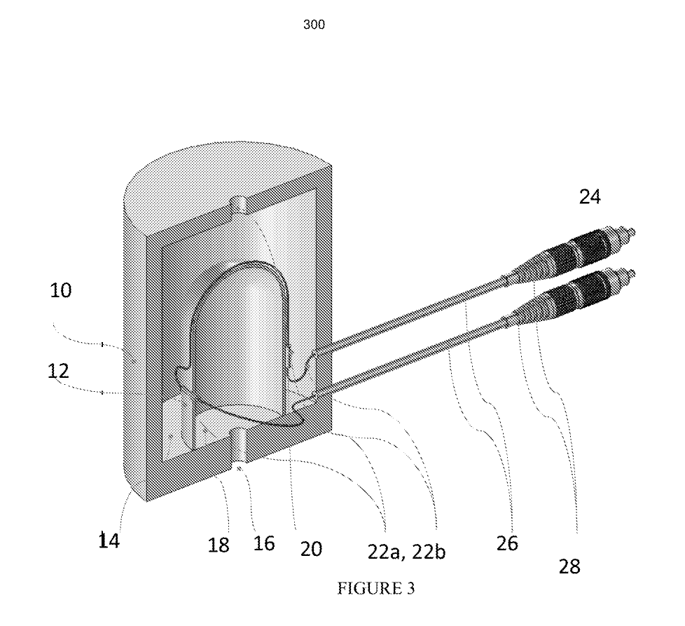

### FIGS. 3, 4, 5

10 sensor housing
12 pressure transmitting element (shell)
14 pressure chamber 1
16 pressure port 1
18 pressure chamber 2
20 pressure port 2
22a, 22b fiber optic sensing elements
24 bare optical fiber
26 jacketed fiber optic cable
28 fiber optic connectors

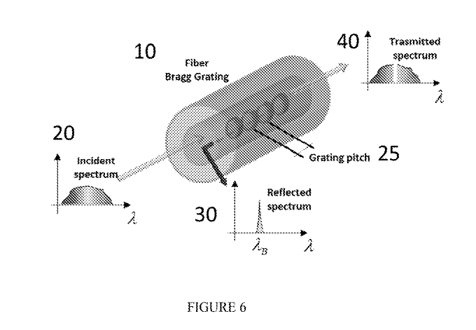

### FIG. 6

10 fiber Bragg grating
20 incoming light source
25 grating and associated pitch
30 reflected spectrum
40 transmitted spectrum

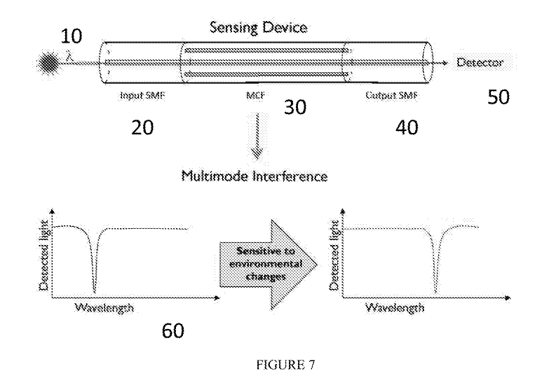

### FIG. 7

10 incoming light source
20 input single mode fiber (SMF)
30 multicore fiber (MCF) sensor
40 output SMF
50 detector
60 wavelength shift according to environmental changes

### DETAILED DESCRIPTION OF NON-LIMITING, EXEMPLARY EMBODIMENTS OF THE INVENTION

FIG. 1 shows a perspective cross sectional view of a pressure sensor 100 according to a first exemplary aspect. The pressure sensor comprises a sensor housing 10 and a pressure transmitting element 12 (plate diaphragm) that defines and separates two adjacent, independent pressure chambers 14, 18 each having a respective pressure port 16, 20. The pressure ports fluidically connect the respective chambers to a pressure source(s) being measured (not shown and not part of the invention per se. The sensor housing may be constructed of any suitable material including but not limited to stainless steel, aluminum, or a polymer (e.g., acrylic), depending on the particular application and working environment (i.e., the working pressure range, corrosive or reactive fluids, etc.) as one skilled in the art would understand. The diaphragm 12 may be made of an elastic material including but not limited to stainless steel or a polymer, again depending upon particular applications and working environments (e.g., pressure range, corrosive or reactive fluids, etc.) and is designed such that it operates within the elastic limit of its material composition.

As illustrated in FIGS. 1 and 2, the housing has a box shape, and in FIGS. 3-5, a cylindrical shape. Other housing shapes are possible as recognized by those skilled in the art.

Under a certain applied pressure, the size (diameter for circular plates or length and width for rectangular plates) and thickness of the diaphragm are the parameters dictating whether the material is within its elastic limit by comparing the resultant stress in the plate to the material yield strength scaled by a preferred safety factor.

The pressure sensor 100 further includes at least two (a primary and a secondary) fiber optic-based sensing units 22a, 22b, which may be, e.g., multicore fiber (MCF)-type or fiber Bragg grating (FBG)-type, as known in the art. The at least two sensing elements will advantageously be of the same operating type (e.g., MCF or FBG). They will advantageously be designed such that their respective operating wavelengths have sufficient margins from each other as appreciated by a person skilled in the art. The sensors may be differently optimized for the sensed quantities (strain, curvature, etc.) desired for where they are installed. The size of the fiber optic sensing elements will determine the size of the housing and the diaphragm. With current fiber optic sensing element technology, the smallest dimension of the housing (either length, width, or diameter) will be about one to a few (3-4) centimeters, as constrained by the bending radius of optical fibers or fiber sensor length (reflective mode sensors). The attachment mechanism can vary according to material, environment, and use-case, including but not limited to micro-machined grooves for fiber placement, high-strength and high-temperature ceramic-based cements, laser-tacking-bonding, as well as more conventional means of fiber sensor handling such as potting and through-hole placement.

In FIG. 1, the at least two fiber optic sensing elements 22a, 22b are disposed on and in-plane of the diaphragm. They are connected in series by bare (unclad) single mode optical fiber 24. The two ends of the bare fibers extend outside of the sensor 100 via connection with jacketed fiber cables 26, which terminate in fiber optic connectors 28. From connectors 28, the sensor can be connected via regular single mode fiber optic cable for communication and read remotely by a selected optical interrogator (not shown and not part of the invention per se).

Light from a light source (not shown), which may be an integrated component of an interrogator but can alternatively be a separate device, is sent into one end of the optical fiber through its connector. This light passes through the sensing element (22a, 22b), or can be reflected from it. The transmitted (or reflected) signal contains measurement information that it carries back to the interrogator. The optical signals from the sensor acquired by the interrogator can then be analyzed and the wavelengths corresponding to the pressure and temperature changes in the sensing elements can be extracted and recorded. These data, collected through a controlled calibration procedure, are fit into statistical regression equation(s) based on a mathematical model representing the physics of the sensor and its sensing elements, which results in the coefficients of the regression equation(s). The regression equations completed by their numerical coefficients are used to calculate pressure and temperature values from any set of wavelengths sent by the sensing elements. An example of the physics-based regression equations is as follows:

$$p = {K}_{p} [ ln ( \frac{{λ}_{p}}{{λ}_{p , ref}} ) - {S}_{1} Δ T - {{S}_{2} ( Δ T )}^{2} ]$$

$$where$$

$$Δ T = \frac{{K}_{T}}{2 {S}_{0}} [ - 1 + sgn ( {S}_{0} ) \sqrt{1 + 4 {S}_{0} ln ( \frac{λ}{{λ}_{T , ref}} )} ]$$

If one chamber is at vacuum, the sensor measures absolute pressure. If one chamber is connected to the atmosphere, the sensor measures gage pressure. If both sensor chambers are connected to unknown pressure sources, the sensor measures differential pressure. In all cases, pressure applied against the diaphragm causes mechanical stress, which can be measured through strain measurements. If there are no temperature changes, one strain measurement is sufficient to determine pressure. However, fiber optic sensing elements by nature are sensitive to temperature, which in reality is always varying. Therefore temperature compensation by using a different sensing element or system reference temperature is advantageous.

The two (primary and secondary) fiber optic elements 22a, 22b, attached on the diaphragm 12 are able to sense radial and tangential strains at their installed positions. Each strain represents an equation of two principal mechanical stresses caused by pressure and one thermal stress caused by temperature. Both of the unknown mechanical stresses relate to pressure through single variable equations. The unknown thermal stress also relates to temperature through a single variable equation. Two strain measurements therefore are sufficient for solving for pressure and temperature simultaneously.

Alternatively, temperature compensation can be done by putting one of the two sensing elements (e.g., the secondary sensing element) at an unstrained site (e.g., attached to the inner housing) where only the temperature effect is sensed. This site will advantageously be in close proximity to the primary sensing element so that the temperature effect on both sensing elements is within ±0.1° C. In this setup, temperature is found from the second strain measurement and pressure from the first one. If there are other stimuli to which the sensing elements are sensitive, additional sensing elements may be used in order to compensate for such stimuli.

FIGS. 2 through 5 illustrate alternative exemplary embodiments. These are selected representative configurations and do not comprise an exhaustive list of all possible configurations of the embodied invention. The differences between the illustrated configurations are in the positions and orientations of the fiber optic sensing elements and their combinations, and in the shape of the pressure transmitting element (diaphragm).

There are three geometric categories of the pressure transmitting elements: flat (plates), curved (shells), and complex structures constructed by plate and shell segments. At least one sensing element, acting as the primary one, should enable direct sensing of the effect of measured pressure as converted by the pressure transmitting element. To accomplish this the primary sensing element (e.g., 22a) can be set up in one of the three (3) positioning arrangements as follows:
1: The optical pressure sensing element (22a) is entirely embedded in or bonded onto the surface of the pressure transmitting element (FIGS. 3, 4, 5). The optical sensing element will undergo bending stress and strain in response to the movement of the pressure transmitting element, yielding a uniaxial force along the length the fiber. This in turn can be measured with conventional optical interrogation means, and similarly with the subsequent examples.
2: The pressure sensing element is located along the fiber so by affixing or bonding one side of the pressure sensing element's (22a) connecting fiber to the pressure transmitting element and the other side of the connecting fiber to a fixed point in the sensor, such as the housing (10). The sensing element will then undergo uniaxial stress and strain as a result of this layout.
3: Both connecting fibers that attach to the pressure sensing element are in turn attached to fixed points that are rigidly connected to the pressure transmitting element, as specifically shown in FIG. 3. The sensing element will experience uniaxial stress and strain as the pressure transmitting element distorts in response to environmental pressure changes.

Generally, the fiber optic sensing elements are sensitive to temperature. A secondary sensing element may be advantageous for temperature compensation. It can be positioned at a site near the primary sensing element but where it is not exposed to the effect of measured pressure (a positioning arrangement 4). It can also take one of the three options listed above, which makes a total of four options for the secondary sensing element.

In summary for each selected pressure transmitting element, there are 12 possible combinations for positioning two sensing elements.

FIG. 2 shows a perspective cross sectional view of a pressure sensor 200 according to a second exemplary aspect. The sensing elements 22a, 22b are set up such that a primary one (22a) follows arrangement 2 above and a secondary one (22b) follows arrangement 4. Primary sensing element 22a is pre-strained with a controlled value of initial strain. It is initially under tension. The diaphragm 12 is initially deflected towards the right chamber 18 a certain calculated amount. When pressure in left chamber 14 is higher than that in chamber 18, the diaphragm 12 deflection increases towards chamber 18 and the tension in the fiber decreases. Since the fiber sensing element, being a string, mechanically, does not work under compression (where mechanical instability happens), initial strain is calculated such that the fiber remains in tension mode under maximum differential pressure. Similarly, when pressure in chamber 18 is higher than that in chamber 14, the diaphragm 12 deflection decreases and fiber tension increases. In order to improve sensitivity at low measurement near the flat (unstressed) condition of the diaphragm, the initial strain is also calculated such that the diaphragm deflection remains in one direction (towards chamber 18) under maximum differential pressure in this case.

For the embodiments presented in FIGS. 3 through 5, the pressure transmitting element is in the form of cylindrical shell with a half-spherical shell cap. This pressure transmitting element 12 divides the interior of the housing into two (inner and outer) chambers 14, 18. Each chamber has a respective pressure port 16, 20. The general functional components are the same as the (flat plate) diaphragm type sensor in FIG. 1, discussed above. The fiber optic circuit is also the same. The differences are in the positioning combination of the sensing elements and their respective operating principles, discussed below.

FIG. 3 shows a perspective cross sectional view of a pressure sensor 300 according to a third exemplary aspect. The sensing elements 22a, 22b are positioned to measured tangential strain and axial strain, respectively. These strain components relate to tangential stress and axial stress through Hooke's law for two-dimensional stress as follows:

$${σ}_{a} = \frac{E}{1 - {v}^{2}} ( {ɛ}_{a} + v {ɛ}_{θ} )$$

$${σ}_{θ} = \frac{E}{1 - {v}^{2}} ( v {ɛ}_{a} + {ɛ}_{θ} )$$

On the other hand, thin-walled pressure vessel theory gives

$${σ}_{a} = \frac{pr}{2 t}$$

$${σ}_{θ} = \frac{pr}{t}$$

If temperature is kept constant, any one of these two sensing elements (advantageously, the one for tangential stress (22a) since its value is higher) is sufficient to provide pressure measurements. In the case temperature is changing, thermal stress terms, as functions of temperature, are added into the mechanical stress equations shown above. The results are a system of two equations with two unknowns (pressure and temperature), which allows this sensor configuration to measure both pressure and temperature. A calibration process and data analysis similar to that discussed for embodiment 100 (FIG. 1) is advantageous in order to obtain higher accuracy measurements.

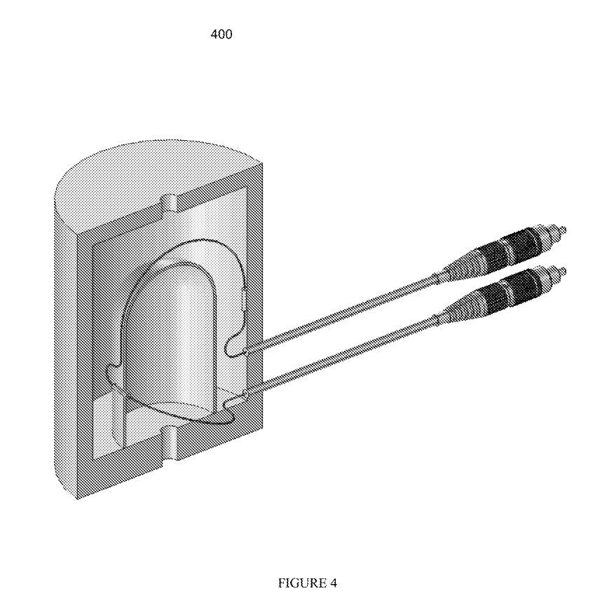

FIG. 4 shows a perspective cross sectional view of a pressure sensor 400 according to a fourth exemplary aspect. The primary sensing elements 22a, is positioned to measure tangential strain and a secondary sensing elements 22b is a temperature compensation sensing element attached to the wall of the housing. Because 22b does not measure the uniaxial strain and only measures temperature, this allows the device shown in arrangement 4 to compensate and correct strain measurements for fluctuations in temperature; then this temperature value is used to eliminate the thermal stress term in the pressure-stress equation and produce pressure value free of thermal artifacts.

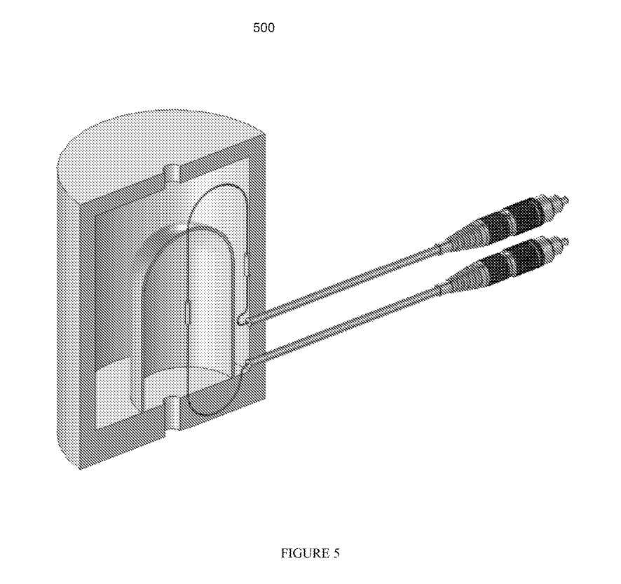

FIG. 5 shows a perspective cross sectional view of a pressure sensor 500 according to a fifth exemplary aspect. The primary sensing element 22a is of arrangement 2 and the secondary sensing element 22b is of arrangement 4. The operating principle is similar to the embodiment of FIG. 2.

It is to be appreciated that the embodied pressure sensor apparatus comprises at least two pressure chambers; at least one pressure port coupled to each of the at least two pressure chambers; and at least one pressure transmitting element (e.g., diaphragm) per every two pressure chambers. The pressure transmitting element(s) may be in the form of flat plates (diaphragms), curved shells, or combinations thereof. Flat plate type pressure transmitting elements may be circular, rectangular, of any other shape, or combinations of these shapes, dependent on the specific application. The shapes of the curved shell forms may be cylindrical, spherical, of any other shape, or combinations of these shapes.

FIG. 6 shows a notional fiber Bragg grating (FBG) sensor. The FBG sensor (10) can measure several physical parameters including for example: strain, temperature, pressure, vibration and displacement. The primary optical FBG mechanism is a permanent periodic refractive index modulation (grating) inscribed in the optical fiber core (25) exploiting photosensitivity. FBG based sensors exploit the presence of a resonance condition whereby the incident spectrum (20) has portions of it reflected (30) at the so-called Bragg wavelength. This portion of the spectrum does not appear in the transmitted spectrum (40). In FBG based sensors any change in either the effective refractive index or the grating pitch (25) caused by external effects like local strain or temperature will result in a Bragg wavelength shift, according to the formula:

Δλ_{B}=λ_{B}[(α+ζ)ΔT+(1−p_{ε})Δε]
where Δλ_{B} is the change in the Bragg wavelength, α and ζ are the thermal expansion and thermo-optic coefficients, p_{ε} is the effective photo-elastic constant of the fiber material and ΔT, Aε are the applied temperature and longitudinal strain variations. Typical values of the wavelength shift (in picometers) due to temperature and strain variations are respectively: 11 pm/K and 1.2 pm/με for a grating with a resonance wavelength λ_{B} in the 1550 nm range, for example.

FIG. 7 shows a notional multicore fiber (MCF) sensor. The MCF sensor can measure several physical parameters including for example: strain, bend, temperature, and pressure. The primary optical MCF mechanism is the thermal dependence of cross talk between closely spaced cores in a common cladding. Most perturbations, including elastic, thermal, acoustic, etc., will influence the optical coupling between cores to some extent. Because of this, a change or disturbance can be sensed by launching a light source (10) into a single mode fiber (SMF) (20) and observing the change in the light distribution as it passes through an MCF sensor (5-15 mm) (30), and back into the SMF (40) for the signal to be interpreted by the appropriate detector (50). In an MCF sensor, the light will switch back and forth between cores as the strength of the disturbance is changed, resulting in an interference pattern with signal integrity approaching 50 decibels (dB) (60).

When light passes through an MCF sensor, it couples back and forth between the cores as it propagates along the length of the sensor. Complete energy exchange from the illuminated to the unilluminated core and back takes place in a beat length 4. The variation in intensity in each core along the length L is a periodic function of the beat phase λ_{b}=πL/λ_{b}. A change in temperature, pressure, or strain causes a change in λ_{b} and an expansion or contraction of the fiber; the net effect is a change in the beat phase. The sensitivity to a perturbation ξ is determined by

$$\frac{d φ}{d ξ} = π L / {λ}_{b} ( \frac{1}{L} \frac{d L}{d ξ} - 1 / {λ}_{b} \frac{d {λ}_{b}}{d ξ} )$$

Software models can help visualize and calculate these effects by using a scalar coupled-mode formulation to evaluate the effects of various perturbations on the distribution of light within the cores. This is also referred to as supermode interference effects as light propagates down the length of an MCF sensor. These kinds of optical interference effects allows for wavelength shift due to temperature and curvature radius due to bending as 30-50 pm/K and 20 nm/mm, respectively, for an MCF sensor.

We claim:

1. A pressure sensor device, comprising:
a pressure chamber housing;
at least two separate pressure chambers within the housing;
at least one pressure port fluidically coupled to each of the at least two pressure chambers;
at least one pressure transmitting element per every two pressure chambers disposed in the pressure chamber, which separates the at least two pressure chambers; and
at least two optical sensing elements disposed in at least one of the pressure chambers, wherein the at least two optical sensing elements are each optically coupled to an optical transmission medium.

2. The pressure sensor device of claim 1, wherein the pressure transmitting element is a diaphragm.

3. The pressure sensor device of claim 2, wherein the pressure transmitting element is a flat-plate diaphragm.

4. The pressure sensor device of claim 3, wherein the flat-plate diaphragm has a curvilinear shape.

5. The pressure sensor device of claim 3, wherein the flat-plate diaphragm has a rectilinear shape.

6. The pressure sensor device of claim 2, wherein the pressure transmitting element is a curved shell.

7. The pressure sensor device of claim 6, wherein the curved shell is cylindrical.

8. The pressure sensor device of claim 6, wherein the curved shell is spherical.

9. The pressure sensor device of claim 1, wherein the pressure transmitting element is a fiber Bragg grating (FBG).

10. The pressure sensor device of claim 9, wherein the fiber Bragg grating is a reflective FBG.

11. The pressure sensor device of claim 9, wherein the fiber Bragg grating is a transmissive FBG.

12. The pressure sensor device of claim 1, wherein the pressure transmitting element is an optical fiber-based interferometric sensor.

13. The pressure sensor device of claim 12, wherein the pressure transmitting element is a multicore fiber (MCF) sensor.

14. The pressure sensor device of claim 1, wherein each of the at least two pressure transmitting elements is disposed in at least one of a perpendicular orientation to the pressure transmitting element, a parallel orientation to the pressure transmitting element, in-plane to the pressure transmitting element, out-of plane to the pressure transmitting element, within at least one of the two separate pressure chambers, and outside of at least one of the two separate pressure chambers.

15. The pressure sensor device of claim 1, wherein the at least two optical sensing elements are configured in at least one of a serial optical, parallel optical, and serial/parallel optical connection.

16. The pressure sensor device of claim 1, wherein the at least two optical sensing elements are disposed in the sensor device by being one of bonded, printed, molded, and micro-fabricated.
